(19) United States
(12) Patent Application Publication
(10) Pub. No.: US 2017/0106217 A1
(43) Pub. Date: Apr. 20, 2017

(54) Cidal Metal or Cidal Metal Alloy Mask

(71) Applicant: Phyllis Kuhn, Girard, PA (US)

(72) Inventor: Phyllis Kuhn, Girard, PA (US)

(21) Appl. No.: 15/395,982

(22) Filed: Dec. 30, 2016

Related U.S. Application Data
(63) Continuation-in-part of application No. PCT/US2015/060228, filed on Nov. 11, 2015.
(60) Provisional application No. 62/078,656, filed on Nov. 12, 2014.

(51) Int. Cl. A62B 23/02; A41D 13/11; A62B 18/08; A62B 18/02

(52) U.S. Cl. CPC A62B 23/02; A62B 18/02; A41D 13/1192; A41D 13/1115; A62B 18/084

(57) ABSTRACT

A mask for covering areas of a wearer's face includes a mask body constructed primarily of a material that includes a cidal metal or cidal metal alloy wherein the cidal metal or cidal metal alloy is the major structural component of the mask body. The mask body covers at least a portion of the wearer's nose or mouth and nose when worn on the wearer's face. A filtering portion of the mask comprises cidal metal mesh or cidal metal alloy mesh for providing cidal action, air purification, and self-disinfection.

### CROSS REFERENCE TO RELATED APPLICATIONS

This is a U.S. Continuation Bypass application of Patent Cooperation Treaty (PCT) Application PCT/US15/060228, filed Nov. 11, 2015, which takes priority from and claims the benefit of U.S. Provisional Patent Application 62/078,656, filed Nov. 12, 2014, both prior applications being incorporated herein by reference.

### BACKGROUND OF THE INVENTION

Facemasks with filtration capabilities are frequently worn for a broad range of purposes and applications. Such masks can include disposable facemasks, such as those cleared by the U.S. Food and Drug Administration (FDA) for use as medical devices and devices worn by medical professionals single and multiple use masks such as dust masks and respirators used in industry and by home consumers, rigid and multi-use masks, and numerous other types used for different environments and circumstances. Some masks are labeled for specific applications such as surgical, dental, medical procedure, isolation, and laser masks.

Such facemasks have several designs. One type is cloth, woven, or flexible material affixed to a wearer's head with two ties, conforming to the face with the aid of a flexible adjustment for the nose bridge, and may be flat/pleated or duck-billed in shape. Another type of facemask is pre-molded or pre-formed, adheres to the head with a single elastic band, and has a flexible adjustment for the nose bridge. A third type is flat/pleated and affixes to the head with ear loops. Respirator-type masks often include removable or replaceable filters and/or exhale valves.

Facemasks cleared by the FDA for use as medical devices have been determined to have specific levels of protection from penetration of blood and body fluids. Facemasks often help stop droplets from being spread by the person wearing them. They are often also used to keep splashes or sprays from reaching the mouth and nose of the facemask wearer, but are often not intended to protect against very small particle aerosols.

Cidal (pathogen and microbial-killing) metals, such as copper, silver, and gold, are often incorporated into the cotton, woven organic, or polymer fabric structural material of a conventional woven or fiber facemask to improve cidal action and air purification due to cidal (killing) antimicrobial properties of such metals. In some cases, cidal solutions can also be applied to the conventional structural mask material. However, even with the application of such cidal substances, the main structural materials of conventional facemasks still present significant problems for wearers.

In conventional woven or fiber masks, the cotton, woven organic, or polymer fabric major structural material does normally provide a physical barrier to water. However, such materials can exhibit wicking when moist, ie, from breath. Once moist, wicking permits bacteria and viruses to penetrate the mask, reducing the mask's filtering effectiveness.

Woven or fiber masks are also single use and not usually suitable for reuse. Attempts to disinfect or sterilize such masks, such as through the use of disinfectants or autoclaving, may have adverse effects on a mask's major structural material by weakening or altering its individual fiber or woven properties. Thus, disposal after a single use often becomes necessary and can be costly and environmentally unsound.

It may be possible to create a reusable mask by molding rubber or plastic/polymer materials into a rigid mask structure and adding a filtering element, but such masks still require the frequent replacement and disposal of the filtering element, which is itself often fiber or woven material. Moreover, the rigid rubber or plastic/polymer structural material may itself harbor bacteria, viruses, and other pathogens. Such masks are both difficult to clean and disinfect or sterilize and require frequent cleanings as such materials generally do not themselves possess cidal properties. Such masks are therefore costly, inefficient for use, less environmentally sound, and less capable of protecting wearers from environmental factors.

Whether used as the major structural material or filtering material of a mask, woven and fiber materials can also be uncomfortable for the wearer. When incorporated into a mask, such materials typically require the exertion of high breathing pressure by the user, can be sufficiently impermeable that undesirable heat and moisture is uncomfortably retained, and can cause fogging of a wearer's glasses or eye protection. During breathing, potentially contaminated air can pass through gaps between the face and the surgical mask, negating the efficacy of the mask.

### SUMMARY OF THE INVENTION

A mask for covering areas of a wearer's face includes a mask body constructed primarily of a material that includes a cidal metal or cidal metal alloy. The cidal metal or cidal metal alloy is also the major structural component of the mask body. The mask body is positioned to cover at least a portion of the wearer's nose, mouth, or nose and mouth when said mask is worn on the wearer's face. Some embodiments can be worn over or under other masks that may not have cidal metal or cidal metal alloy as the major structural component.

The mask includes a filtering portion also comprising cidal metal mesh or cidal metal alloy mesh. The cidal metal or cidal metal alloy mesh provides cidal action and air purification. The cidal metal or cidal metal alloy mesh of the filtering portion has an average wire diameter and an average width of opening that is sufficiently small to prevent, due to water surface tension, the penetration of water through the filtering portion. However, to allow for mask disinfection or sterilization and reuse, the filtering portion mesh also has an average wire diameter and an average opening width of sufficient size to allow penetration of disinfecting solution with a lower surface tension than water or steam under pressure (autoclaving).

The filtering portion of the mask, comprising cidal metal or cidal metal alloy mesh, can either itself form the major structural component of the mask body or can be a separate fixed or removable mask component. In some embodiments, the use of cidal metal or cidal metal alloy in the combined or separate mask body and filtering portion allows for alternative means of additional mask disinfection or sterilization through methods such as heating or autoclaving.

### BRIEF DESCRIPTION OF THE DRAWINGS

For a more complete understanding and appreciation of this invention, and its many advantages, reference will be made to the following Detailed Description of the Invention taken in conjunction with the accompanying drawings.

FIG. 1 is a perspective view of a copper mesh mask positioned on the face of a wearer according to one embodiment of the invention;

FIG. 2 is a front view of the copper mesh mask of FIG. 1;

FIG. 2A is a left side view of the copper mesh mask of FIG. 1;

FIG. 2B is right cross sectional view of the copper mesh mask of FIG. 1 along line 2B-2B of FIG. 2;

FIG. 3 is a perspective view of a copper mesh mask positioned on the face of a wearer according to one embodiment of the invention;

FIG. 4 is a front view of the copper mesh mask of FIG. 3;

FIG. 4A is a left side view of the copper mesh mask of FIG. 3;

FIG. 4B is right cross sectional view of the copper mesh mask of FIG. 3 along line 4B-4B of FIG. 4;

FIG. 5A is a right cross sectional view of the top of a mask according to one embodiment of the invention;

FIG. 5B is a right cross sectional view of the top of a mask according to one embodiment of the invention;

FIG. 5C is a right cross sectional view of the top of a mask according to one embodiment of the invention;

FIG. 5D is a right cross sectional view of the top of a mask according to one embodiment of the invention;

FIG. 5E is a right cross sectional view of the top of a mask according to one embodiment of the invention;

FIG. 6 is a front view of a mesh mask according to one embodiment of the invention;

FIG. 6A is a left side view of the mesh mask of FIG. 6;

FIG. 6B is a right cross sectional view of the mesh mask of FIG. 6 along line 6B-6B of FIG. 6;

FIG. 7 is a front view of a mesh mask according to one embodiment of the invention;

FIG. 7A is a left side view of the mesh mask of FIG. 7;

FIG. 7B is a right cross sectional view of the mesh mask of FIG. 7 along line 7B-7B of FIG. 7;

FIG. 8 is a perspective view of a mask according to one embodiment of the invention;

FIG. 9 is a perspective view of a mask according to one embodiment of the invention;

FIG. 10 is a perspective view of a copper mesh mask positioned on the face of a wearer according to one embodiment of the invention;

FIG. 11 is a perspective view of a mask according to one embodiment of the invention;

FIG. 12 is a perspective view of a mask according to one embodiment of the invention; and

FIG. 13 is a perspective view of a mask according to one embodiment of the invention.

### DETAILED DESCRIPTION OF THE INVENTION

Referring to the drawings, some reference numerals are used to designate the same or corresponding parts through several of the embodiments and figures shown and described. Variations in corresponding parts are denoted in specific embodiments with the addition of lowercase letters. Subsequent variations in components that are depicted in the figures but not described are intended to correspond to the specific embodiments mentioned earlier and are discussed to the extent that they vary in form or function. It will be understood generally that variations in the embodiments could be interchanged without deviating from the intended scope of the invention.

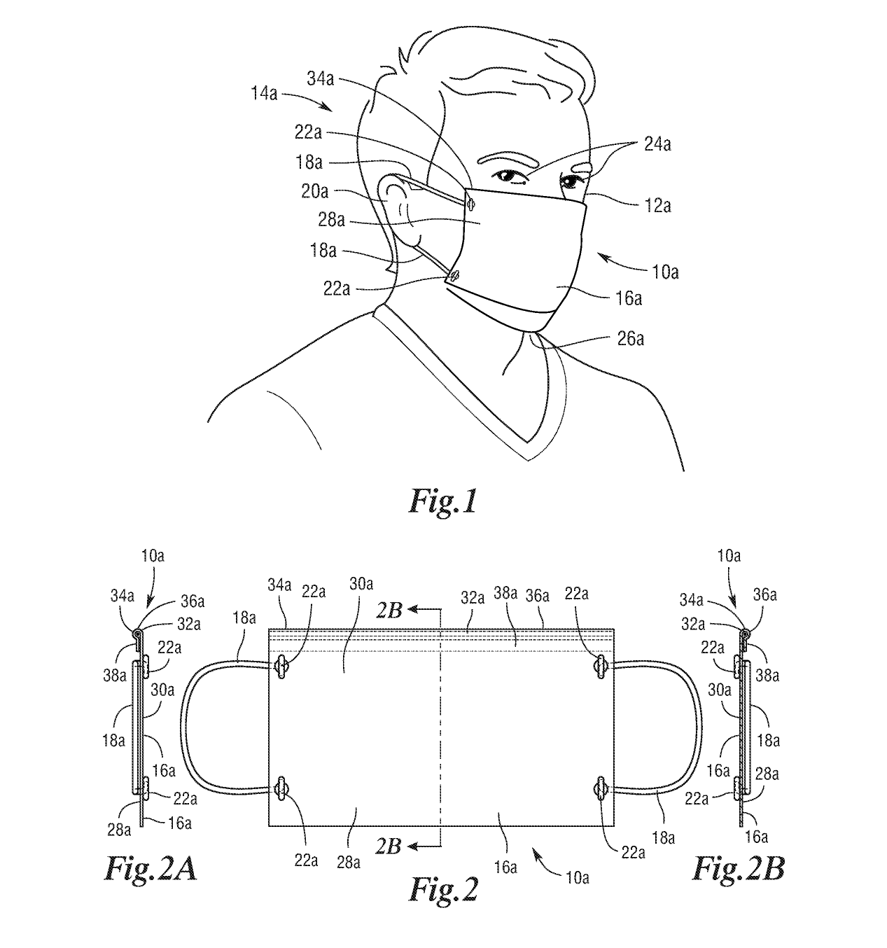

FIG. 1 is a perspective view of a mask 10a positioned on the face 12a of a wearer 14a. The mask 10a includes a mask body 16a that is secured to the wearer's face 12a with elastic bands 18a. The elastic bands 18a loop around the wearer's ears 20a, extend through the mask body 16a, and are anchored to the mask 10a with fasteners 22a. In this embodiment, the mask body 16a is sized to extend from below the wearer's eyes 24a, over the nostrils of the wearer's nose and completely over the wearer's mouth, to just above the bottom of the wearer's chin 26a.

The construction of the mask 10a is best understood by comparing the perspective view of the mask 10a on the face 12a of the wearer 14a in FIG. 1 with the front view of the mask 10a in FIG. 2 and left side view of the mask 10a in FIG. 2A. A right side cross sectional view of the mask 10a along the line 2B-2B in FIG. 2 is depicted in FIG. 2B.

The body 16a of the mask 10a is constructed of copper mesh 28a, copper being a cidal metal that is capable of killing most pathogens and microorganisms but is not harmful to humans. As the wearer breathes through the mask, the mesh 28a also releases copper ions that can adhere to the wearer's mucus linings and potentially help prevent some illnesses such as colds. The copper mesh 28a is also highly effective for filtering out most particulate matter. Further, copper possesses anti-inflammatory properties and is potentially capable of shrinking inflamed nasal membranes and sinus swelling, possibly increasing user comfort. In this conceptual example of FIGS. 1 through 2B, the body 16a is copper mesh having an approximate wire diameter of 0.0045 inches and width opening of 0.00555 inches with approximately 30.3% open area and with approximately 100×100 mesh per linear inch, such as item #100×100 0.0045 cu or similar item available from the Belleville Wire Cloth Company of Cedar Grove, N.J. The copper mesh 28a of the mask 10a in FIGS. 1 through 2B forms the mask body 16a. Thus, the copper material of the mesh 28a is itself the major structural component of the mask body 16a and is also a filtering portion 30a for providing cidal action and air purification. Although this illustrative example utilizes copper as the major structural component of the mask body 16a, it will be appreciated that other cidal metals or cidal metal alloys such silver, gold, bronze, brass, and more exotic cidal alloys can also be used as the major structural component of the mask 10a within the contemplated scope of the current invention. Such other cidal metals or cidal metal alloys can also be used as filtering portions of the mask. It will be further appreciated that the mask 10a can also be sized to be worn over or under another mask that may not have cidal metal or cidal metal alloy as the major structural component within in the intended scope of the invention. This would normally be done to improve overall pathogen-killing effectiveness as a mask not having cidal metal or cidal metal alloy as its major structural component would be inherently less effective at providing cidal action and air purification.

The copper mesh 28a is hydrophobic such that poured water and water droplets tend to not penetrate the mask due to natural water surface tension. Thus, water applied to the mask body 16a tends to bead up rather than pass through or being absorbed into the copper mesh 28a. The illustrated example of FIGS. 1 through 2B contemplates copper mesh having an approximate wire diameter of 0.0045 inches and approximate width opening of 0.00555 inches and with approximately 100×100 mesh per linear inch. It will be appreciated that some preferred embodiments utilize mesh with similar water-repelling hydrophobic characteristics. Meshes with wire diameters of approximately 0.0014 to 0.0045 inches and approximate width openings of 0.00170 to 0.00555 inches and with approximately 100×100 to 325×325 mesh per linear inch are likely to exhibit similar hydrophobic characteristics. It is further contemplated any such cidal metal mesh or cidal metal alloy mesh with a wire diameter less than approximately 0.0100 inches, and preferably less than approximately 0.0070 inches, could be appropriately implemented.

Although such ranges repel and resist wicking penetration of water, such ranges also allow for disinfection, subsequent reuse of masks with disinfecting agents, and easy breathing by the wearer such that air flows through the mesh and not in or out of gaps caused by high air pressure in masks made of denser materials. Low isopropyl alcohol surface tension would allow for penetration of the copper mesh 28a of the mask 10a of FIGS. 1 through 2B and therefore allow the use of alcohol for mask disinfection. A 70% isopropyl alcohol solution would have a lower surface tension than water, permitting the use of such a solution as a disinfectant for the same mask 10a. These structural disinfection advantages would be in addition to the natural disinfection that would occur and be ongoing due to both the filtering portion 30a and major structural component/mask body 16a being cidal copper. In some embodiments, it could be further advantageous to affect additional disinfecting or sterilizing by heating or autoclaving a mask. For example, in FIGS. 1 through 2B, the body 16a of the mask 10a might be heated or autoclaved, especially after temporary removal of the elastic bands 18a and fasteners 22a.

It is contemplated that in some embodiments, components that are not major structural components of the mask, such as the elastic bands 18a and fasteners 22a of FIGS. 1 through 2B, may also be constructed of or at least partially contain copper or another cidal metal or cidal metal alloy. For example, the presence of additional copper in such non-major structural components would allow for the exposure of additional copper ions to air surrounding the face 12a of the wearer 14a and would therefore further enhance surrounding air purification.

Other non-major structural components can also be added to some contemplated embodiments to improve the fit or positioning of a mask on a wearer's face, and in some embodiments, can also be partially or completely constructed of cidal metal or a cidal metal alloy. For example, the mask 10a of FIGS. 1 through 2B includes a flexible positioning rod 32a (not shown in FIG. 1) at the top edge 34a of the mask body 16a which is secured with an over fold 36a and small excess 38a of mesh 28a. The positioning rod 32a is constructed of a material such as metal or metal alloy that features a shape memory allowing the wearer to bend the rod 32a into a shape that improves the fit of the mask 10a over the wearer's nose. The over fold 36a and excess 38 of the mesh 28a also improve the stiffness and fit of the mask 10a when formed to fit with the rod 32a. The metal construction of the rod 32a can be completely or partially cidal metal or cidal metal alloy to enhance the exposure of cidal metal ions and also allows for additional disinfection of the mask 10a through heating or autoclaving.

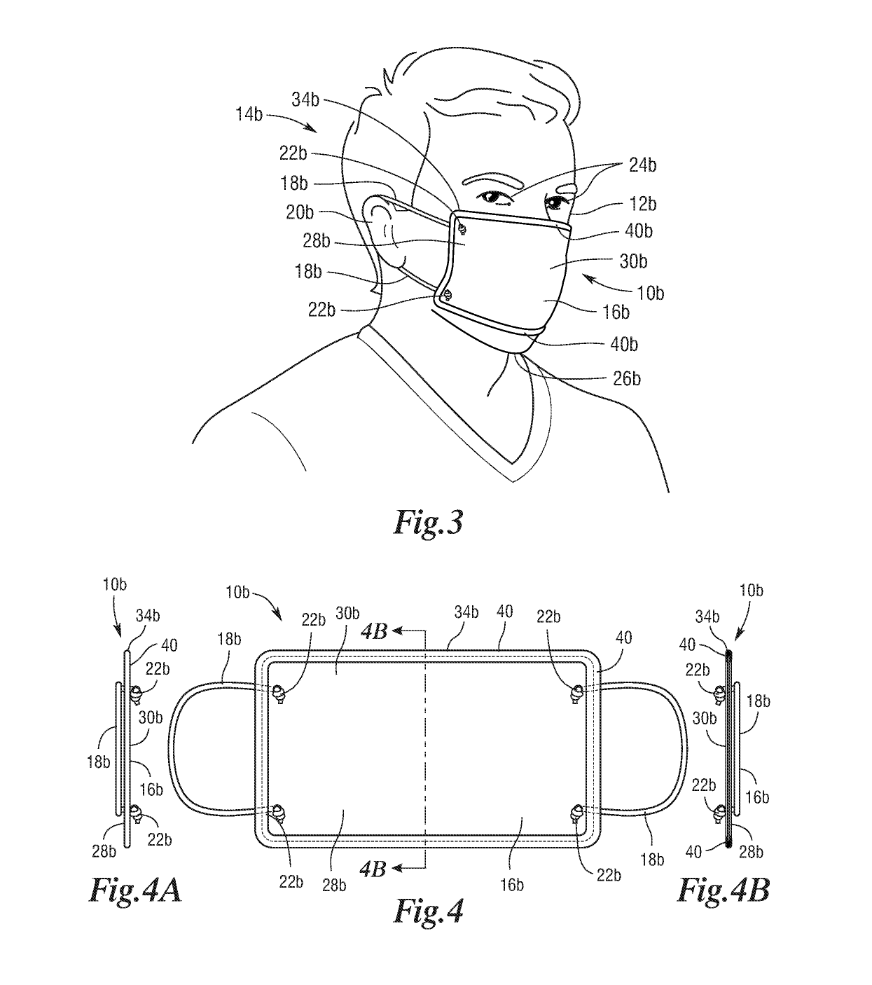

Additional components can also be added to improve rigidity, positioning, or sealing of a mask against a wearer's face. Referring to FIG. 3, a copper mesh mask 10b according to one contemplated embodiment is shown having a perimeter barrier 40 to improve closure and stiffening and reduce the space gap between the mask 10b and face 12b of the wearer 14b. Front, side and side cross sectional views of the mask 10b of FIG. 3 are depicted in FIGS. 4 through 4B. Since the perimeter barrier 40 is attached around the perimeter of the mask 10b but is not itself part of the copper mesh 28a forming the mask body 16b, the barrier 40 can be constructed of a non-cidal metal materials such as woven cloth or rubber within the contemplated scope of the invention. Alternatively, the perimeter barrier 40 can be constructed of a non-metal cloth or fiber material with cidal metal or cidal metal alloy materials added into the cloth or fiber material, which would allow the barrier 40 to contribute to the cidal action and/or air purification capabilities of the mask 10b. As a further alternative, the perimeter barrier 40 can itself be completely constructed of a cidal metal or cidal metal alloy materials such as copper, which would maximize the contribution of the barrier 40 to the overall cidal action and/or air purification capabilities of the mask 10b and possibly allowing for sterilization via heating or autoclaving without requiring removal of the barrier 40 or damaging the mask 10b. The use of simple knot fasteners 22b further facilitates such disinfection or sterilization activities by allowing for easy removal and replacement of the elastic bands 18b.

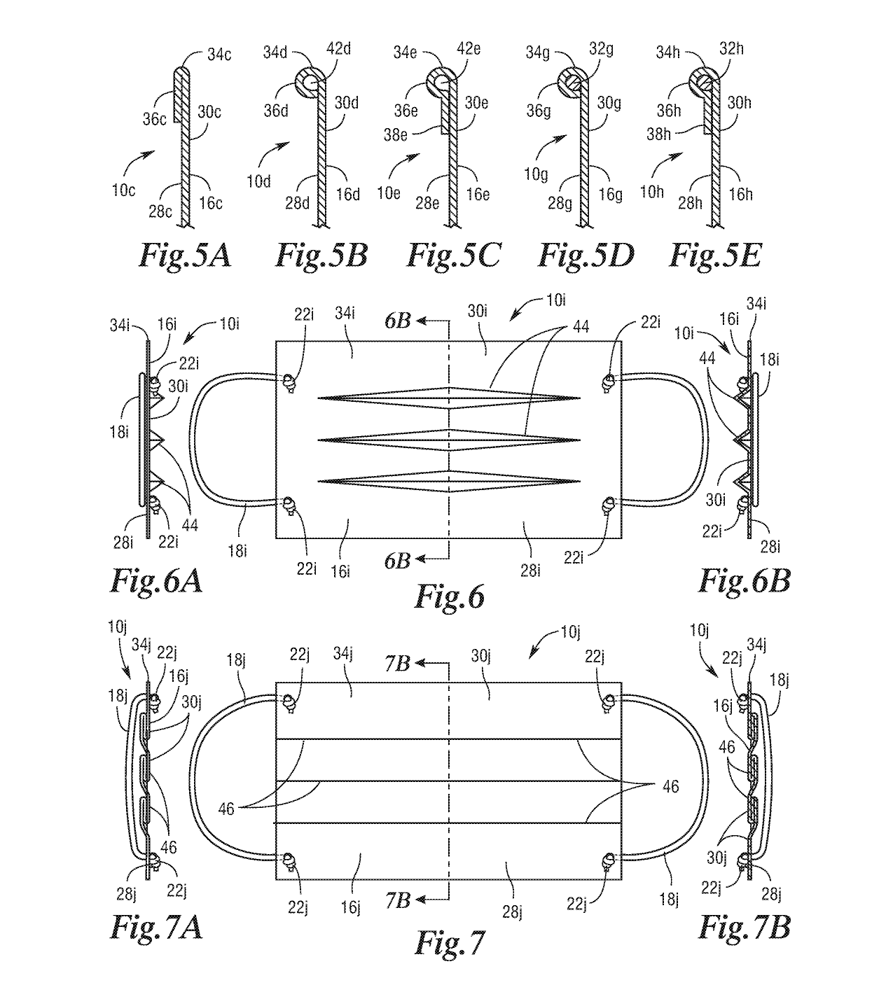

Although the invention has been shown and described with optional stiffening rods and perimeter barriers positioned along mask edges and perimeters, it will be appreciated that several edge and perimeter constructions are possible within the anticipated scope of the invention. For example, FIG. 5A is a right cross sectional view of the top of a mask 10c in which cidal metal mesh 28c of the mask body 16c is simply folded over along the top edge 34c of the mask 10c to create an over fold 36c of metal mesh that stiffens the mask body 16c. Similar folding can also be located along the side and bottom edges of the mask 10c to increase overall mask rigidity.

FIG. 5B depicts a looped over fold 36d along the top edge 34d of a mask 10d according to one contemplated embodiment in which the looped configuration of the over fold 36d leaves an over fold space 42d. In comparison, FIG. 5B can be compared to the mask 10e of FIG. 5C in which the looped over fold 36e ends with an excess 38e of mesh 28c positioned flush and in planar contact with the filtering portion 30e of mask body 16e, further enhancing mask stiffness FIGS. 5D and 5E, respectively, depict the top edges 34g and 34h of masks 10g and 10h similar to those of FIGS. 5B and 5C with the addition of positioning rods 32g and 32h in FIGS. 5D and 5E occupying the over fold spaces 42d and 42e of FIGS. 5B and 5C for further stiffening and positioning of the masks 10g and 10h. The resulting configuration of the top edge 34h of the mask 10h of FIG. 5E is therefore similar to the mask 10a shown and described in FIGS. 2 through 2B.

It is also possible to manipulate mask rigidity by providing various configurations of mesh bending in the body and filtering portions of a cidal metal or cidal metal alloy mask. FIG. 6 depicts a front view mask 10i of the invention with a left side view of the mask 10i depicted in FIG. 6A and a right cross sectional view along line 6B-6B of FIG. 6 depicted in FIG. 6B. Multiple pleats 44 are added to the copper mesh 28i of the mask body 16i which are best understood by comparing the front view of FIG. 6 with the side and side cross sectional views of FIGS. 6A and 6B. The pleats 44 extend horizontally and partially along the width of the body 16i and filtering portion 30i of the mask 10i. In addition to increasing the overall stiffness of the mask 10i, the pleats also provide additional angled surface area to allow increased air interaction with the filtering portion 30i and copper ions in the mesh 28i of the mask body 16i to enhance cidal action and air purification. The use of fastener knots 22i allows for easy removal of the elastic bands 18i for supplemental disinfection or sterilization of the mask 10i through heating or autoclaving.

Other bent mesh configurations are also possible. For example, FIG. 7 depicts a front view mask 10j of the invention with a left side view of the mask 10j depicted in FIG. 7A and a right cross sectional view along line 7B-7B of FIG. 7 depicted in FIG. 7B. Multiple folds 46 are added to the copper mesh 28j of the mask body 16j which are best understood by comparing the front view of FIG. 7 with the side and side cross sectional views of FIGS. 7A and 7B. The folds 46 extend horizontally along the full width of the body 16j and filtering portion 30j of the mask 10j. Like the pleating 44 in FIGS. 6 through 6B, the folds 46 in FIGS. 7 through 7B also increase the overall stiffness of the mask 10j. The folds 46 further provide an easily manufactured means for stiffening the mask 10i while providing additional layering of copper mesh 28j. Such additional layering allows increased air interaction with the filtering portion 30j and copper ions in the mesh 28j of the mask body 16j to enhance cidal action and air purification. Fastener knots 22j are also used in this contemplated embodiment to allow for easy removal of the elastic bands 18j.

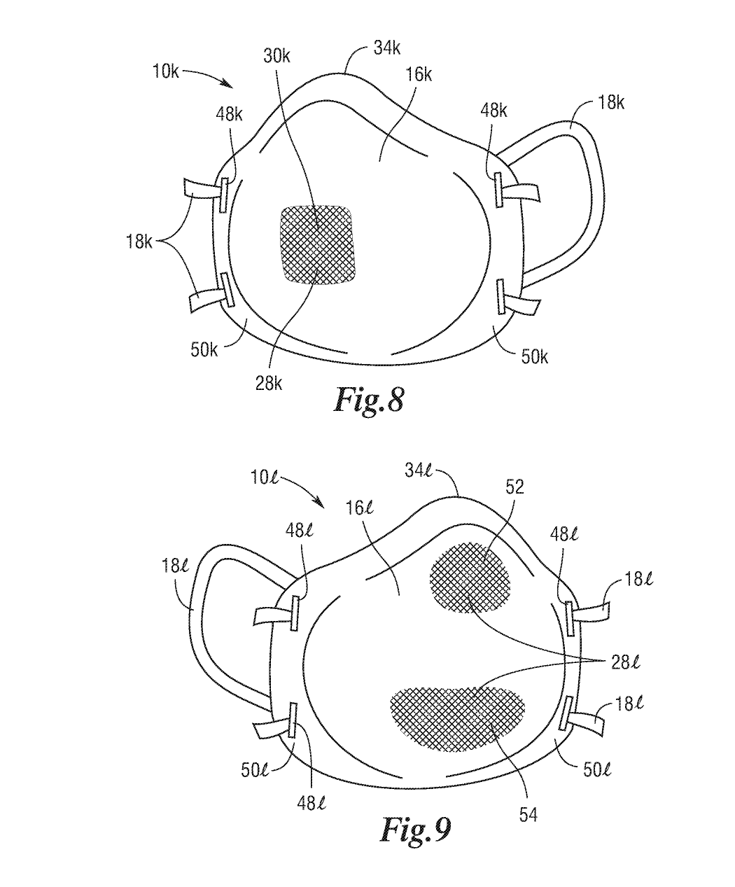

Although the invention has been shown and described where cidal metal or cidal metal alloy mesh forms both the mask body and the filtering portion of the mask, it will be appreciated that masks having separate mask bodies and filtering portions are also possible and within the contemplated scope of the invention. For example, FIG. 8 depicts a mask 10k of the invention having a rigid stamped or molded copper mask body 16k and a separate copper mesh filtering portion 30k. In FIG. 8, the filtering portion 30k is shaded to distinguish its location on the mask 10k relative to the mask body 16k.

In this illustrative example of FIG. 8, the mask body 16k is entirely copper, which is therefore the body's major structural component. Copper mesh 28k is used for the filtering portion 30k, which may be directly fused, welded, bonded, or joined to the mask body 16k itself. The copper mesh 28k may also be fabricated during the manufacture of the mask body 16k such that the filtering portion 30k and mask body 16k are stamped or otherwise formed from and into a continuous piece of copper. As the mask body 16k is a rigid and impermeable copper structure, air flow due to wearer breathing is channeled by the mask body 16k to the filtering portion 30k, although the copper of the mask body 16k also effects cidal action during this channeling, enhancing the overall cidal and air purification effectiveness and efficiency of the mask 10k. While the invention is described in FIG. 8 as having both a mask body and filtering portion made of copper, it will be appreciated that different cidal metals or cidal metal alloys can also be used or combined within the contemplated scope of the invention.

Elastic bands 18k connect to the pinch slits 48k through side flaps 50k of the mask body 16k. The pinch slits 48k allow for both easy adjustment by the wearer and easy elastic band removal from and reinstallation on to the mask 10k. This feature of this contemplated embodiment may be especially useful where frequent supplemental disinfection or sterilization of the mask 10k through heating or autoclaving is either desirable or required.

The invention also contemplates the utilization of multiple filtering portions where the filtering portion is distinct from the rest of the mask body. FIG. 9 depicts a mask 10l of the invention similar to that depicted in FIG. 8 but with a separate upper filtering portion 52 and lower filtering portion 54. In FIG. 9, both the upper filtering portion 52 and lower filtering portion 54 are shaded to distinguish their locations on the mask 10l relative the mask body 16l.

The upper filtering portion 52 is positioned closer to the top edge 34l of the mask 10l proximate the wearer's nose and the lower filtering portion 54 is positioned proximate the wearer's mouth when the mask 10l is positioned correctly on the wearer's face. This configuration relies less one the channeling of air by the mask body 16l to the filtering portion 30l, allows for easier breathing, and results in more efficient cidal action and air purification by the mask 10l itself. Both the upper filtering portion 52 and lower filtering portion 54 are constructed of cidal metal or cidal metal alloy mesh joined to the cidal metal alloy of the mask body 16l, facilitating additional disinfection through heating or autoclaving. For this reason, it is further advantageous to utilize elastic bands 18l connected to pinch slits 48l through side flaps 50l of the mask body 16l to allow for easy elastic band removal from and reinstallation on to the mask 10l.

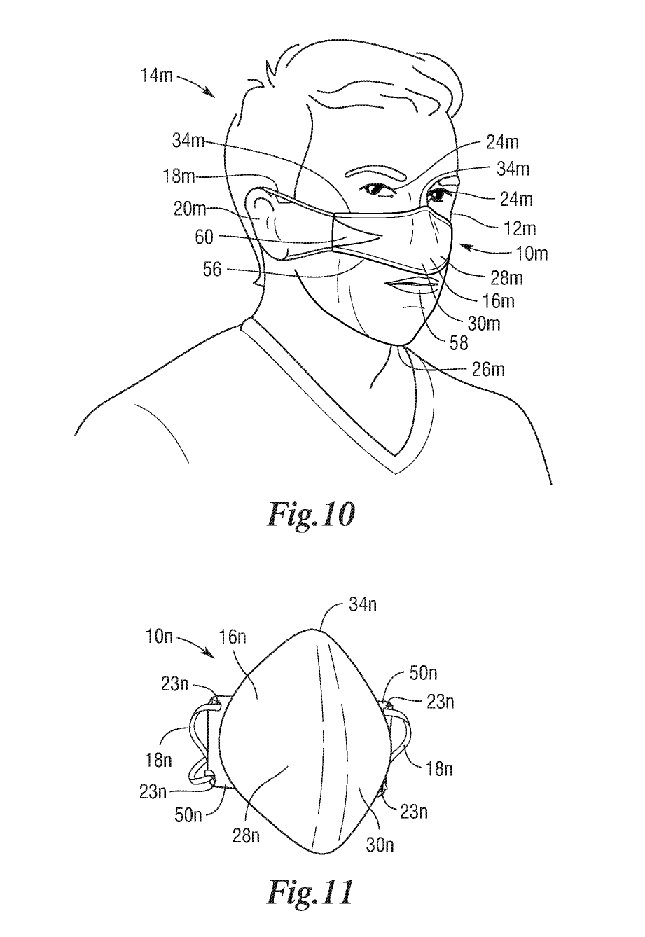

Although the mask has been shown and described as covering both the nose and mouth of a wearer, it will be appreciated that masks that cover only the mouth or only the nose of a wearer are also within the contemplated scope of the invention. For example, FIG. 10 depicts a copper mesh mask 10m positioned on the face 12m of a wearer 14m where the copper mesh 28m forms both the mask body 16m and filtering portion 30m. When positioned on the face 12m of the wearer 14m, the top edge 34m of the mask 10m extends just below the wearer's eye 24m while the bottom edge 56 remains above the wearer's mouth 58, covering only the wearer's nose.

While the mask 10m is positioned on the wearer's face 12m, the elastic bands 18m stretch around the wearer's ears 20m to secure the mask 10m in place. As the bands 18m pull on the copper mesh 28m of the mask 10m, the bands 18m also pinch the ends of the mask 10m such that the top edge 34m and bottom edge 56 are drawn closer together, the extent of pinching depending on features, such as nose size, of the wearer's face 12m. The wearer 14m will then fold over the copper mesh 28m, creating a triangle shaped tuck 60 that enables the mask body 16m to better hug the wearer's face 12m and nose. The size of the tuck 60 normally varies depending on the wearer's facial features, with larger noses resulting in smaller tucks 60 and smaller noses resulting in larger tucks 60. For the copper mesh mask 10m depicted in FIG. 10, one appropriate copper mesh for the mask body 16m and filtering portion 30m would have an approximate wire diameter of 0.0037 inches and width opening of 0.0046 inches with approximately 30.7% open area and with approximately 120×120 mesh per linear inch, such as item #120×120 0.0037 cu, also available from the Belleville Wire Cloth Company of Cedar Grove, N.J. The inclusion of tucks 60 with a mask 10m constructed of such mesh 28m would allow for substantial cidal action and air purification of the mask 10m. It will be further appreciated that a mask covering only a wearer's mouth but not the nose, using similar copper mesh or other cidal metal materials, could also be constructed for cidal action and air purification within the intended scope of the invention.

It is further contemplated that a mask covering only the nose or only the mouth of a wearer could in some embodiments be constructed to avoid the need for tucks in the metal mesh mask body. For example, FIG. 11 depicts a cidal metal mesh mask 10n of the invention designed to fit over only the nose of the wearer but not the wearer's mouth. Rigid flaps 50n, which are part of the mask body 16n, are constructed of a cidal metal or cidal metal alloy and allow for attachment of elastic bands 18n while resisting pinching of the mask body 16n and filtering portion 30n and therefore avoiding the need for tucks for optimal mask positioning. The filtering portion 30n of the mask body 16n is also cidal metal mesh or cidal metal alloy mesh 28n to effect cidal action and air purification. Therefore, the cidal metal or cidal metal alloy used in the flaps 50n and filtering portion 30n is the major structural component of the mask body 16n. Staples 23 are used to secure the elastic bands 18n to the flaps 50n as an alternate means of attachment to the mask 10n. It is contemplated that in some embodiments, the staples 23 are constructed of a cidal metal or a cidal metal alloy as well.

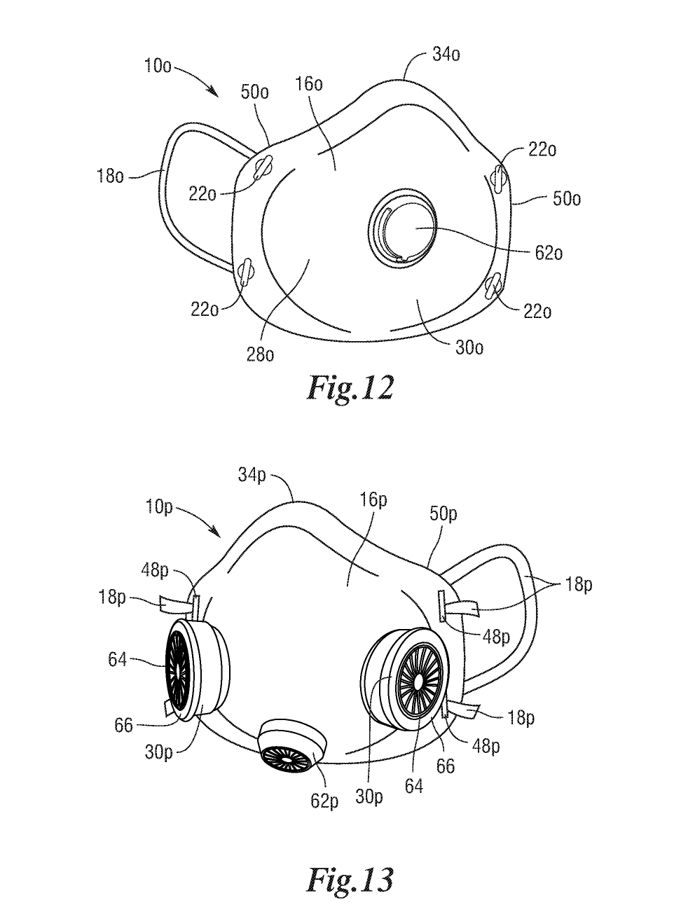

It will be further appreciated the invention can be appropriately implemented in respirator type masks as well. For example, FIG. 12 depicts a mask 10o of the invention formed or stamped into a semi-rigid respirator shape having a copper mesh mask body 16o with flaps 50o to allow the attachment of elastic bands 18o via fasteners 22o. Although the mask body 16o is constructed of permeable copper mesh 28o for effecting cidal action and air purification, an exhale valve 62o is also included to further facilitate the escape of exhaled moisture from the mask 10o. An appropriately implemented exhale valve significantly limits or prevents air from entering a respirator-type mask but allows a significant portion of exhaled air to escape the mask to further limit moisture buildup in the space between the wearer's face and mask body. Such valves are commercially available, such as the COOL FLOW™ Respirator Valve available from the 3M Company of St. Paul, Minn. It is further contemplated that in some embodiments, some or all of the components of the exhale valve 62o can be constructed of a cidal metal or cidal metal alloy to further effect cidal action and air purification.

Although the invention has been shown and described with fixed or non-removable filtering portions, it will be appreciated some embodiments of the invention may include filtering portions that are consumable and/or removable. For example, FIG. 13 depicts a respirator-type mask 10p of the invention having an impermeable, non-mesh mask body 16p wherein the mask body 16p is constructed of a formed or stamped cidal metal or cidal metal alloy that contributes to the cidal action and air purification capabilities of the mask 10p. The mask 10p includes an exhale valve 62p to reduce moisture accumulation in the space between the wearer's face and mask body 16p when the mask 10p is worn. The exhale valve 62p may be removable and both the exhale valve 62p and mask body 16p threaded to allow for easy exhale valve 62p removal and reinstallation.

The filtering portions 30p of the mask 10p comprise two removable filters 64 that each include a filter housing 66 enclosing a cidal metal mesh or cidal metal alloy mesh filter element (enclosed by the filter housing 66 and not visible in FIG. 13). While the filter element effects much of the cidal and air purification action of the mask 10p, it is contemplated that many embodiments within the intended scope of the invention would utilize copper, or another cidal metal or cidal metal alloy in several or all of the components of the exhale valve 62p and removable filter 64 to complement the mask body 16p and mesh filter elements in enhancing the overall cidal and air purification capabilities of the mask 10p.

Both the filter housing 66 and mask body 16p may be threaded to allow for easy removal and reinstallation of the filter 64. It is further contemplated that during typical cycles of usage, the exhale valve 62p and filter 64 would be regularly removed from the mask body 10p, and the mesh filter elements removed from the filter housing 66, to facilitate disinfection of the mask body 16p and other mask components such as the exhale valve 62p, mesh filter elements, and filter housing 66 via heating or autoclaving. The mask 10p includes pinch slits 48p in flaps 50p to allow for easy removal and replacement of the elastic bands 18p during such routine disinfection or sterilization.

Although the invention has been shown and described throughout the various example embodiments as being secured to wearers' faces using elastic bands for attachment behind wearers' ears, it will be appreciated that other means for attachment are also possible within the contemplated scope of the invention, such single elastic bands for securement around a wearer's head, single or multiple ties, straps, belts, bands, temporary facial adhesives, or any other form of temporary mask attachment that allows for the proper positioning over a wearer's nose, mouth, or nose and mouth for cidal action and air purification by the mask.

Those skilled in the art will realize that this invention is capable of embodiments different from those shown and described. It will be appreciated that the detail of the structure of the disclosed apparatuses and methodologies can be changed in various ways without departing from the invention itself. Accordingly, the drawings and Detailed Description of the Invention are to be regarded as including such equivalents as do not depart from the spirit and scope of the invention.

1. A mask for covering areas of a wearer's face, said mask comprising:
a mask body, said mask body being constructed primarily of a material that includes a cidal metal or cidal metal alloy wherein said cidal metal or cidal metal alloy is the major structural component of said mask body;
said mask body being positioned to cover at least a portion of the wearer's mouth, nose, or mouth and nose when said mask is worn on the wearer's face; and
said mask having a filtering portion, said filtering portion comprising cidal metal mesh or cidal metal alloy mesh for providing cidal action, air purification, and self-disinfection.

2. The mask of claim 1 wherein said filtering portion kills fungi, pathogens, and microorganisms.

3. The mask of claim 1 wherein said filtering portion filters dust and particles.

4. The mask of claim 1 further comprising a perimeter barrier to improve closure between said mask body and the wearer's face.

5. The mask of claim 1 further comprising a stiffener wire to position said mask relative the wearer's nose when said mask is worn on the wearer's face.

6. The mask of claim 1 further comprising pleats on said filtering portion.

7. The mask of claim 1 further comprising folds on said filtering portion.

8. The mask of claim 1 wherein said major structural component of said mask body is flexible mesh.

9. The mask of claim 1 wherein said major structural component is formed into a rigid mask body.

10. The mask of claim 1 wherein said filtering portion is removable from said mask body.

11. The mask of claim 1 wherein said filtering portion has an average wire diameter and an average width of opening of sufficient size to prevent the penetration of water through said filtering portion.

12. The mask of claim 1 wherein said filtering portion has an average wire diameter and an average width of opening of sufficient size to allow the penetration of disinfecting solution that is isopropyl alcohol solution through said filtering portion.

13. The mask of claim 1 wherein said cidal metal or cidal metal alloy is at least one of copper, silver, gold, bronze, brass, copper alloy, gold alloy, silver alloy, or exotic cidal alloy.

14. A mask for covering areas of a wearer's face, said mask comprising:
a mask body, said mask body being constructed primarily of a material that includes a cidal metal or cidal metal alloy wherein said cidal metal or cidal metal alloy is the major structural component of said mask body;
said mask body being positioned to cover at least a portion of the wearer's mouth, nose, or mouth and nose when said mask is worn on the wearer's face;
said mask having a filtering portion, said filtering portion comprising cidal metal mesh or cidal metal alloy mesh for providing cidal action, air purification, and self-disinfection;
said filtering portion having an average wire diameter and an average width of opening of sufficient size to prevent, due to water surface tension, the penetration of water through said filtering portion; and
said filtering portion having an average wire diameter and an average width of opening of sufficient size to allow, due to disinfecting solution surface tension that is less than water surface tension, the penetration of disinfecting solution through said filtering portion.

15. The mask of claim 14 wherein said filtering portion kills fungi, pathogens, and microorganisms.

16. The mask of claim 14 wherein said filtering portion filters dust and particles.

17. The mask of claim 14 further comprising a perimeter barrier to improve closure between said mask body and the wearer's face.

18. The mask of claim 14 further comprising a stiffener wire to position said mask relative the wearer's nose when said mask is worn on the wearer's face.

19. The mask of claim 14 further comprising pleats on said filtering portion.

20. The mask of claim 14 further comprising folds on said filtering portion.

21. The mask of claim 14 wherein said major structural component of said mask body is flexible mesh.

22. The mask of claim 14 wherein said major structural component is formed into a rigid mask body.

23. The mask of claim 14 wherein said filtering portion is removable from said mask body.

24. The mask of claim 14 wherein said cidal metal or cidal metal alloy is at least one of copper, silver, gold, bronze, brass, copper alloy, gold alloy, silver alloy, or exotic cidal alloy.

25. The mask of claim 14 wherein said filtering portion has an average wire diameter and an average width of opening of sufficient size to allow the penetration of disinfecting solution that is alcohol or alcohol solution through said filtering portion.

26. The mask of claim 14 wherein said average wire diameter of said mesh is about 0.0045 inches.

27. The mask of claim 14 wherein said average wire diameter of said mesh is between about 0.0014 and 0.0045 inches.

28. The mask of claim 14 wherein said average wire diameter of said mesh is less than about 0.0070 inches.

29. The mask of claim 14 wherein said average wire diameter of said mesh is less than about 0.0100 inches.

30. The mask of claim 14 wherein said average width openings of said mesh is between about 0.0070 and 0.00555 inches.

31. The mask of claim 14 wherein said average width openings of said mesh is less than about 0.0100 inches.

32. A mask for covering the nose of a wearer's face, said mask comprising:
a mask body, said mask body being constructed primarily of a material that includes a cidal metal or cidal metal alloy wherein said cidal metal or cidal metal alloy is the major structural component of said mask body;
said mask body being positioned to cover at least a portion of the wearer's nose when said mask is worn on the wearer's face;
said mask body having a filtering portion, said filtering portion comprising cidal metal mesh or cidal metal alloy mesh for providing cidal action, air purification, and self-disinfection;
said filtering portion having an average wire diameter and an average width of opening of sufficient size to prevent, due to water surface tension, the penetration of water through said filtering portion; and
said filtering portion having an average wire diameter and an average width of opening of sufficient size to allow, due to disinfecting solution surface tension that is less than water surface tension, the penetration of disinfecting solution through said filtering portion.

33. The mask of claim 32 wherein said filtering portion kills fungi, pathogens, and microorganisms.

34. The mask of claim 32 wherein said filtering portion filters dust and particles.

35. The mask of claim 32 further comprising a perimeter barrier to improve closure between said mask body and the wearer's face.

36. The mask of claim 32 further comprising a stiffener wire to position said mask relative the wearer's nose when said mask is worn on the wearer's face.

37. The mask of claim 32 further comprising pleats on said filtering portion.

38. The mask of claim 32 further comprising folds on said filtering portion.

39. The mask of claim 32 wherein said major structural component of said mask body is flexible cidal metal or flexible cidal metal alloy mesh.

40. The mask of claim 32 wherein said major structural component is formed into a rigid cidal metal or rigid cidal metal alloy mask body.

41. The mask of claim 32 wherein said filtering portion is removable from said mask body.

42. The mask of claim 32 wherein said cidal metal or cidal metal alloy is at least one of copper, silver, gold, bronze, brass, copper alloy, gold alloy, silver alloy, or exotic cidal alloy.

43. The mask of claim 32 wherein said filtering portion has an average wire diameter and an average width of opening of sufficient size to allow the penetration of disinfecting solution that is alcohol or alcohol solution through said filtering portion.

44. The mask of claim 32 wherein said average wire diameter of said mesh is about 0.0045 inches.

45. The mask of claim 32 wherein said average wire diameter of said mesh is between about 0.0014 and 0.0045 inches.

46. The mask of claim 32 wherein said average wire diameter of said mesh is less than about 0.0070 inches.

47. The mask of claim 32 wherein said average wire diameter of said mesh is less than about 0.0100 inches.

48. The mask of claim 32 wherein said average width openings of said mesh is between about 0.0070 and 0.00555 inches.

49. The mask of claim 32 wherein said average width openings of said mesh is less than about 0.0100 inches.

50. A mask for covering areas of a wearer's face, said mask comprising:
a mask body, said mask body being constructed primarily of copper or copper alloy wherein said copper or copper alloy is the major structural component of said mask body;
said mask body being positioned to cover at least a portion of the wearer's mouth, nose, or mouth and nose when said mask is worn on the wearer's face;
said mask body having a filtering portion, said filtering portion comprising copper mesh or copper alloy mesh for providing cidal action, air purification, and self-disinfection;
said filtering portion having an average wire diameter and an average width of opening of sufficient size to prevent, due to water surface tension, the penetration of water through said filtering portion; and
said filtering portion having an average wire diameter and an average width of opening of sufficient size to allow, due to disinfecting solution surface tension that is less than water surface tension, the penetration of disinfecting solution through said filtering portion.

51. The mask of claim 50 wherein said filtering portion kills fungi, pathogens, and microorganisms.

52. The mask of claim 50 wherein said filtering portion filters dust and particles.

53. The mask of claim 50 further comprising a perimeter barrier to improve closure between said mask body and the wearer's face.

54. The mask of claim 50 further comprising a stiffener wire to position said mask relative the wearer's nose when said mask is worn on the wearer's face.

55. The mask of claim 50 further comprising pleats on said filtering portion.

56. The mask of claim 50 further comprising folds on said filtering portion.

57. The mask of claim 50 wherein said major structural component of said mask body is flexible copper mesh or copper alloy mesh.

58. The mask of claim 50 wherein said major structural component is formed into a rigid copper or rigid copper alloy mask body.

59. The mask of claim 50 wherein said filtering portion is removable from said mask body.

60. The mask of claim 50 wherein said filtering portion has an average wire diameter and an average width of opening of sufficient size to allow the penetration of disinfecting solution that is alcohol or alcohol solution through said filtering portion.

61. The mask of claim 50 wherein said average wire diameter of said mesh is about 0.0045 inches.

62. The mask of claim 50 wherein said average wire diameter of said mesh is between about 0.0014 and 0.0045 inches.

63. The mask of claim 50 wherein said average wire diameter of said mesh is less than about 0.0070 inches.

64. The mask of claim 50 wherein said average wire diameter of said mesh is less than about 0.0100 inches.

65. The mask of claim 50 wherein said average width openings of said mesh is between about 0.0070 and 0.00555 inches.

66. The mask of claim 50 wherein said average width openings of said mesh is less than about 0.0100 inches.

67. A mask for covering areas of a wearer's face, said mask comprising:
a mask body, said mask body being constructed primarily of a material that includes a cidal metal mesh or cidal metal alloy mesh wherein said cidal metal mesh or cidal metal alloy mesh includes a filtering portion for providing cidal action, air purification, and self-disinfection, said filtering portion of said cidal metal mesh or said cidal metal alloy mesh being the major structural component of said mask body;
said mask body being positioned to cover at least a portion of the wearer's mouth, nose, or mouth and nose when said mask is worn on the wearer's face;
said filtering portion having an average wire diameter and an average width of opening of sufficient size to prevent, due to water surface tension, the penetration of water through said filtering portion; and
said filtering portion having an average wire diameter and an average width of opening of sufficient size to allow, due to disinfecting solution surface tension that is less than water surface tension, the penetration of disinfecting solution through said filtering portion.

68. The mask of claim 67 wherein said filtering portion kills fungi, pathogens, and microorganisms.

69. The mask of claim 67 wherein said filtering portion filters dust and particles.

70. The mask of claim 67 further comprising a perimeter barrier to improve closure between said mask body and the wearer's face.

71. The mask of claim 67 further comprising a stiffener wire to position said mask relative the wearer's nose when said mask is worn on the wearer's face.

72. The mask of claim 67 further comprising pleats on said filtering portion.

73. The mask of claim 67 further comprising folds on said filtering portion.

74. The mask of claim 67 wherein said cidal metal or cidal metal alloy is at least one of copper, silver, gold, bronze, brass, copper alloy, gold alloy, silver alloy, or exotic cidal alloy.

75. The mask of claim 67 wherein said filtering portion has an average wire diameter and an average width of opening of sufficient size to allow the penetration of disinfecting solution that is alcohol or alcohol solution through said filtering portion.

76. The mask of claim 67 wherein said average wire diameter of said mesh is about 0.0045 inches.

77. The mask of claim 67 wherein said average wire diameter of said mesh is between about 0.0014 and 0.0045 inches.

78. The mask of claim 67 wherein said average wire diameter of said mesh is less than about 0.0070 inches.

79. The mask of claim 67 wherein said average wire diameter of said mesh is less than about 0.0100 inches.

80. The mask of claim 67 wherein said average width openings of said mesh is between about 0.0070 and 0.00555 inches.

81. The mask of claim 67 wherein said average width openings of said mesh is less than about 0.0100 inches.

82. A mask for covering areas of a wearer's face, said mask comprising:
a mask body, said mask body being constructed primarily of a material that includes a copper mesh or copper alloy mesh wherein said copper mesh or copper alloy mesh includes a filtering portion for providing cidal action, air purification, and self-disinfection, said filtering portion of said copper mesh or said copper alloy mesh being the major structural component of said mask body;
said mask body being positioned to cover at least a portion of the wearer's mouth, nose, or mouth and nose when said mask is worn on the wearer's face;
said filtering portion having an average wire diameter and an average width of opening of sufficient size to prevent, due to water surface tension, the penetration of water through said filtering portion; and
said filtering portion having an average wire diameter and an average width of opening of sufficient size to allow, due to disinfecting solution surface tension that is less than water surface tension, the penetration of disinfecting solution through said filtering portion.

83. The mask of claim 82 wherein said filtering portion kills fungi, pathogens, and microorganisms.

84. The mask of claim 82 wherein said filtering portion filters dust and particles.

85. The mask of claim 82 further comprising a perimeter barrier to improve closure between said mask body and the wearer's face.

86. The mask of claim 82 further comprising a stiffener wire to position said mask relative the wearer's nose when said mask is worn on the wearer's face.

87. The mask of claim 82 further comprising pleats on said filtering portion.

88. The mask of claim 82 further comprising folds on said filtering portion.

89. The mask of claim 82 wherein said filtering portion has an average wire diameter and an average width of opening of sufficient size to allow the penetration of disinfecting solution that is alcohol or alcohol solution through said filtering portion.

90. The mask of claim 82 wherein said average wire diameter of said mesh is about 0.0045 inches.

91. The mask of claim 82 wherein said average wire diameter of said mesh is between about 0.0014 and 0.0045 inches.

92. The mask of claim 82 wherein said average wire diameter of said mesh is less than about 0.0070 inches.

93. The mask of claim 82 wherein said average wire diameter of said mesh is less than about 0.0100 inches.

94. The mask of claim 82 wherein said average width openings of said mesh is between about 0.0070 and 0.00555 inches.

95. The mask of claim 82 wherein said average width openings of said mesh is less than about 0.0100 inches.

96. A method for purifying and disinfecting air comprising:
providing a mask for covering areas of a wearer's face, said mask having a mask body, said mask body being constructed primarily of a material that includes a cidal metal or cidal metal alloy wherein said cidal metal or cidal metal alloy is the major structural component of said mask body;
positioning said mask body to cover at least a portion of the wearer's mouth, nose, or mouth and nose when said mask is worn on the wearer's face; and
providing a filtering portion of said mask, said filtering portion comprising cidal metal mesh or cidal metal alloy mesh for providing cidal action, air purification, and self-disinfection.

97. A method for purifying and disinfecting air comprising:
providing a mask for covering areas of a wearer's face, said mask having a mask body, said mask body being constructed primarily of a material that includes a copper mesh or copper alloy mesh wherein said copper mesh or copper alloy mesh includes a filtering portion for providing cidal action, air purification, and self-disinfection, said filtering portion of said copper mesh or said copper alloy mesh being the major structural component of said mask body;
positioning said mask body to cover at least a portion of the wearer's mouth, nose, or mouth and nose when said mask is worn on the wearer's face;
providing on said filtering portion an average wire diameter and an average width of opening of sufficient size to prevent, due to water surface tension, the penetration of water through said filtering portion; and
providing on said filtering portion an average wire diameter and an average width of opening of sufficient size to allow, due to disinfecting solution surface tension that is less than water surface tension, the penetration of disinfecting solution through said filtering portion.
